(19) United States
(12) Patent Application Publication
(10) Pub. No.: US 2025/0116195 A1
(43) Pub. Date: Apr. 10, 2025

(54) MULTI-PIECE RADIAL TURBINE WITH CERAMIC MATRIX COMPOSITE BLADES FOR GAS TURBINE ENGINES

(71) Applicant: Rolls-Royce North American Technologies Inc., Indianapolis, IN (US)

(72) Inventors: Matthew T. Kush, Indianapolis, IN (US); Michael D. Wood, Indianapolis, IN (US); William Williamson, Indianapolis, IN (US)

(21) Appl. No.: 18/481,750

(22) Filed: Oct. 5, 2023

(51) Int. Cl. F01D 5/32; F01D 5/04; F01D 5/28

(52) U.S. Cl. CPC F01D 5/02

(57) ABSTRACT

A radial turbine rotor incorporating ceramic matrix composite turbine blades is disclosed. The radial turbine rotor can include an axially-extending lug features for coupling the ceramic matrix composite turbine blades to a central hub.

### FIELD OF THE DISCLOSURE

The present disclosure relates generally to radial turbines, and more specifically to radial turbine rotors.

### BACKGROUND

Radial turbine rotors are characterized by rotating in response to a flow of working fluid radially inwardly toward the axis of rotation. In many applications, radial turbine rotors can be more efficient than axial turbine rotors that rotate in response to a flow of working fluid primarily parallel to the axis of rotation.

To increase efficiency of radial turbine rotors, it can be beneficial to increase the temperature of the working fluid that interacts with the rotors. However, manufacturing radial turbine rotors from high temperature materials and/or incorporating an active supply of cooling air into radial turbines presents challenges.

### SUMMARY

The present disclosure may comprise one or more of the following features and combinations thereof in an effort to address challenges in radial turbine rotor design and manufacture.

A radial turbine rotor illustratively includes a metallic hub and ceramic matrix composite turbine blades coupled to the hub. The hub extends around a central axis and is shaped to have a generally diminishing diameter from a forward end to an aft end. The turbine blades are each shaped to include an airfoil contoured to interact with gasses passing over the rotor and a root that extends radially inward from the airfoil.

In illustrative embodiments, the root of each of the plurality of turbine blades is coupled to the hub by a catch lug. The catch lug that extends in a primarily axial direction into a corresponding forward channel to block movement of the turbine blades in a radially outward direction away from the hub.

In illustrative embodiments, the rotor also includes a retainer. The retainer is mounted along an aft face of the hub and the turbine blades to block axially aft movement of the plurality of turbine blades relative to the hub.

In illustrative embodiments, the retainer includes a retention ring having a hub portion and a ring lug portion. The hub portion is arranged adjacent to an aft face of the hub and the turbine blades. The ring lug portion is coupled to the hub by a ring lug that extends in a primarily axial direction into a corresponding aft channel to block movement of the turbine blades in a radially outward direction away from the hub.

In illustrative embodiments, the forward channel extends primarily in an axially forward direction into the hub. The aft channel extends primarily in an axially forward direction into the root of each of the plurality of turbine blades. The forward channel can be located radially outward of the aft channel.

In illustrative embodiments, the retainer further includes a shaft. The shaft is engaged with radially-inward facing surfaces of both the hub and the retention ring to couple the turbine rotor components together for rotation about the axis.

In illustrative embodiments, each of the plurality of turbine blades is further formed to include a platform. The platform extends circumferentially between airfoils of adjacent turbine blades to shield at least a portion of the hub radially inward of the platform.

These and other features of the present disclosure will become more apparent from the following description of the illustrative embodiments.

### BRIEF DESCRIPTION OF THE DRAWINGS

FIG. 1 is a perspective view of a radial turbine rotor assembled from a number of different pieces including turbine blades comprising ceramic matrix composite material suitable for use in high temperature applications;

FIG. 2 is a perspective view of a cutaway portion of a radial turbine rotor showing that the rotor includes a metallic hub and retainer coupled to the turbine blades by axially-extending lugs received in corresponding channels to fix the turbine blades in place relative to the rest of the rotor;

FIG. 3 is an exploded perspective assembly view of a radial turbine rotor showing, from right to left, the hub, the turbine blades, and the retainer; and

FIG. 4 is a sectional view of a radial turbine rotor showing the axially extending lugs that block radially outward movement of the turbine blades when the rotor is assembled.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

A radial turbine rotor 10 of the present disclosure is configured to extract energy from a working fluid, such as hot, high pressure combustion products, flowing through a gas path 18. The radial turbine rotor 10 rotates about a central axis 11 to extract mechanical work from the flow of working fluid to drive other components of the gas turbine engine. The flow of working fluid in the radial turbine rotor 10 may be, at least in majority part, radial to the central axis 11.

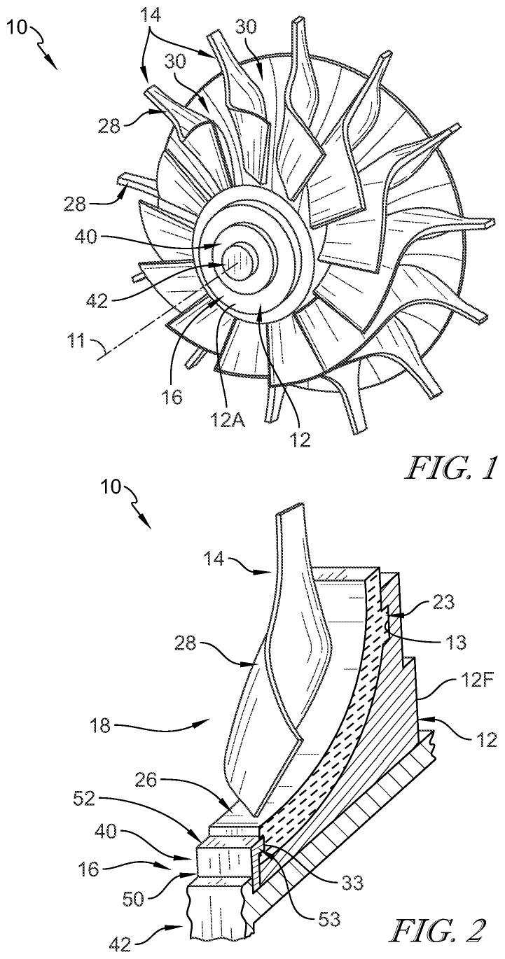

The radial turbine rotor 10 of the present disclosure is adapted for use in a gas turbine engine. The rotor 10 includes a hub 12 made of metallic materials, turbine blades 14 made of ceramic matrix composite materials (CMCs), and a retainer 16. The retainer 16 facilitates coupling of the CMC turbine blades 14 to metallic the hub 12 as shown in FIGS. 1-4.

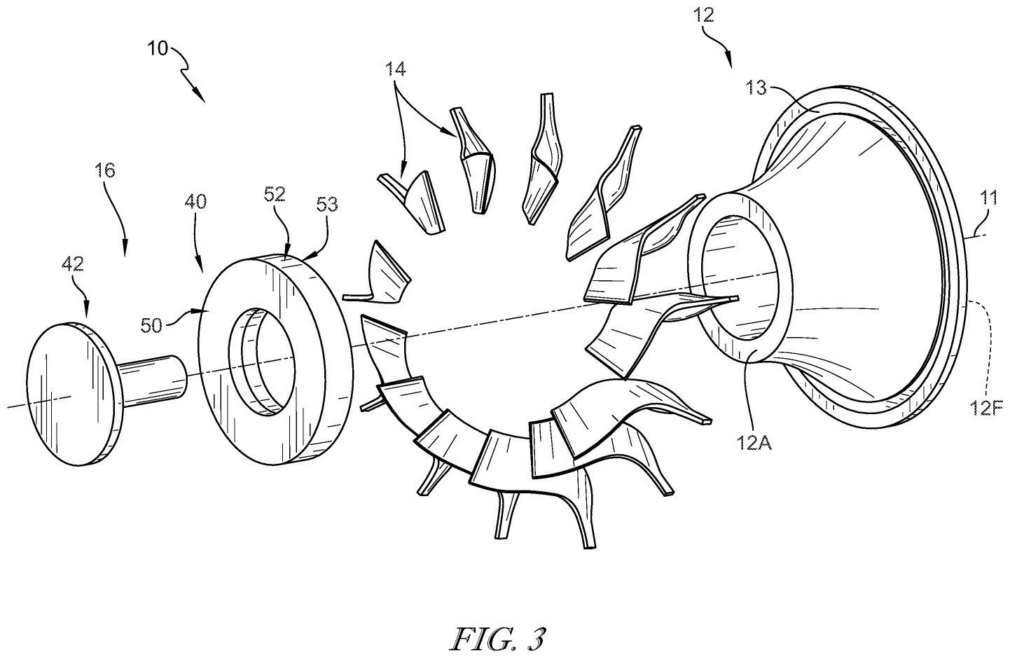

The hub 12 is shaped to have a generally diminishing diameter from a forward end 12F to an aft end 12A as shown in FIGS. 2 and 3. The hub 12 defines a forward channels 13 that is annular and extend primarily in a forward direction along the central axis 11. The turbine blades 14 are inserted into the channels 13 to couple the blades 14 to the hub 12 without fasteners.

In some embodiments, the hub 12 comprises nickel superalloy, such as, but not limited to, Udimet 720. In some embodiments, the hub 12 comprises nickel powder alloy, such as, but not limited to, RR1000. In some embodiments, the hub 12 comprises polycrystalline nickel-based superalloy, such as, but not limited to, Mar-M-247. In the illustrative embodiment, the hub 12 is integrally formed (cast/forged/machined) as a single component.

The turbine blades 14 are able to withstand relatively high temperatures on account of the CMC material used to create the blades 14. In the illustrative embodiment, the blades 14 comprise silicon-carbide fibers in a silicon-carbide matrix (SiC-SiC). The turbine blades 14 are coupled to the hub 12 via axially extending lugs.

Each of the plurality of turbine blades 14 is shaped to include a root 26 and an airfoil 28 as shown in FIGS. 2-4. The root 26 includes a catch lug 23 that extends forward along the axis 11 into the forward channel 13 of the hub 12. The root 26 is also illustratively formed to include an aft channel 33 that extends primarily in a forward direction along the axis 11. The airfoil 28 extends radially-outward for interaction with hot gasses that flow over the radial turbine rotor 10 during use.

Each of the plurality of turbine blades 14 can be formed to include a platform 30 as shown in FIG. 1. Each of the optional platforms 30 extend circumferentially between airfoils 28 of adjacent turbine blades 14 to shield the hub 12 radially inward of the platform 30.

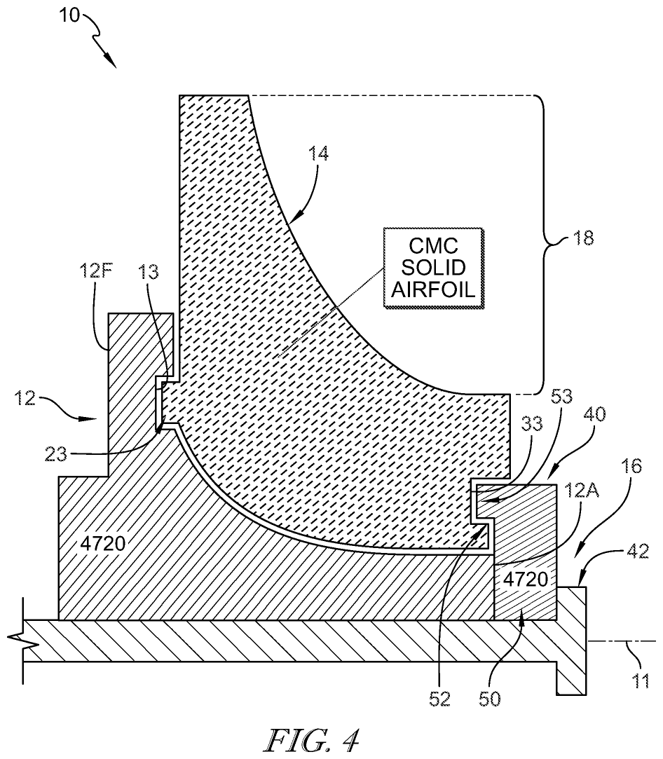

The retainer 16 is illustratively mounted along the aft face 12A of the hub 12 to block undesired movement of the turbine blades 14 in the aftward direction as shown in FIG. 4. The retainer 16 includes a retention ring 40 and a shaft 42. The retention ring 40 engages the aft face 12A of the hub 12 and the turbine blades 14. The shaft 42 of the retainer 16 is engaged via interference fit with radially-inward facing surfaces of both the hub 12 and the retention ring 40 to couple the turbine rotor 10 components together for rotation about the axis 11.

The retainer 16 of the exemplary embodiment has a hub portion 50 arranged adjacent to an aft face of the hub 12 and a ring lug portion 52. The ring lug portion 52 is coupled to the hub 12 by a ring lug 53 that extends in a primarily axial direction into the aft channel 33 formed in the root 26 of the blades 14 to block movement of the turbine blades 14 in a radially outward direction away from the hub 12. In the illustrative embodiment, the ring lug 53 and the aft channel 33 are arranged radially inward of the catch lug 13 and forward channel 23 that couple the turbine blades 14 directly to the hub 12.

While the disclosed embodiment shows lugs 13, 53 coupling the turbine blades 14 to the hub 12 in one specific arrangement, other arrangements are contemplated. For example, lugs could extend forward and aft from the turbine blade into corresponding channels formed in the hub and/or the retainer. Alternately, lugs could extend forward and aft into the root of the turbine blades from the hub and the retainer. These and other combinations of axially-extending lug couplings are contemplated.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A radial turbine rotor, the rotor comprising:
a hub comprising metallic materials shaped to have a generally diminishing diameter from a forward end to an aft end, the hub formed to include a forward channel that extends primarily in an axially forward direction into the hub, and
a plurality of turbine blades comprising ceramic matrix composite materials, each of the plurality of turbine blades shaped to include an airfoil shaped for interaction with hot gasses that flow over the radial turbine rotor during use and a root with a catch lug that extends into the forward channel to block radially outward movement of the turbine blade relative to the hub.

2. The rotor of claim 1, further including a retainer mounted along an aft face of the hub to block axially aft movement of the plurality of turbine blades relative to the hub.

3. The rotor of claim 2, wherein the retainer includes a retention ring having a hub portion arranged adjacent to an aft face of the hub and a ring lug portion that extends from the hub portion into an aft channel extending primarily in an axially forward direction into root of each of the plurality of turbine blades.

4. The rotor of claim 2, wherein the retainer further includes a shaft engaged with radially-inward facing surfaces of both the hub and the retention ring to couple the turbine rotor components together for rotation about the axis.

5. The rotor of claim 1, wherein each of the plurality of turbine blades is further formed to include a platform that extends circumferentially between airfoils of adjacent turbine blades to shield at least a portion of the hub radially inward of the platform.

6. A radial turbine rotor, the rotor comprising:
a hub that extends around a central axis, the hub comprising metallic materials shaped to have a generally diminishing diameter from a forward end to an aft end, and
a plurality of turbine blades comprising ceramic matrix composite materials, each of the plurality of turbine blades shaped to include an airfoil that shaped to interact with gasses passing over the rotor and a root that extends radially inward from the airfoil,
wherein the root of each of the plurality of turbine blades is coupled to the hub by a catch lug that extends in a primarily axial direction into a corresponding forward channel to block movement of the turbine blades in a radially outward direction away from the hub.

7. The rotor of claim 6, further including a retainer mounted along an aft face of the hub and the plurality of turbine blades to block axially aft movement of the plurality of turbine blades relative to the hub.

8. The rotor of claim 7, wherein the retainer includes a retention ring having a hub portion arranged adjacent to an aft face of the hub and a ring lug portion that is coupled to the hub by a ring lug that extends in a primarily axial direction into a corresponding aft channel to block movement of the turbine blades in a radially outward direction away from the hub.

9. The rotor of claim 8, wherein the aft channel extends primarily in an axially forward direction into the root of each of the plurality of turbine blades.

10. The rotor of claim 9, wherein the forward channel extends primarily in an axially forward direction into the hub.

11. The rotor of claim 11, wherein the forward channel is located radially outward of the aft channel.

12. The rotor of claim 8, wherein the retainer further includes a shaft engaged with radially-inward facing surfaces of both the hub and the retention ring to couple the turbine rotor components together for rotation about the axis.

12. The rotor of claim 6, wherein each of the plurality of turbine blades is further formed to include a platform that extends circumferentially between airfoils of adjacent turbine blades to shield at least a portion of the hub radially inward of the platform.

13. The rotor of claim 6, wherein the forward channel extends primarily in an axially forward direction into the hub at a location radially outward of the aft channel.
